(19) United States
(12) Patent Application Publication
(10) Pub. No.: US 2015/0009689 A1
(43) Pub. Date: Jan. 8, 2015

(54) LED STRIP LAMP HOLDER AND LIGHT BULB

(71) Applicant: Lediamond Opto Corporation, New Taipei City (TW)

(72) Inventors: Peng-Yu CHEN, New Taipei City (TW); Chung-Ting TSENG, New Taipei City (TW)

(73) Assignee: Lediamond Opto Corporation, New Taipei City (TW)

(21) Appl. No.: 14/168,000

(22) Filed: Jan. 30, 2014

(30) Foreign Application Priority Data
Jul. 8, 2013 (TW) 102124362

(51) Int. Cl. F21K 99/00

(52) U.S. Cl. CPC F21K 9/30
USPC 362/382

(57) ABSTRACT

A lamp holder includes an insulating lamp base, a pair of lead frames and an LED strip assembly. The insulating lamp base has two spaced apart through holes. The pair of lead frames is separately inserted in the two through holes. Each lead frame includes a heat conducting section and a supporting section. One end of the heat conducting section is inserted in the through hole, and the other end of the heat conducting section is connected with the supporting section. The two heat conducting sections are extended from the insulating lamp base to separate the two supporting sections from a surface of the insulating lamp base with a distance. The LED strip assembly includes a transparent carrier board, a plural of LED chips and a first transparent glue layer .The transparent carrier board is disposed crossing the two supporting sections.

### BACKGROUND OF THE INVENTION

1. Field of the Invention

The present invention generally relates to an LED lamp and, in particular to an LED strip lamp holder and a light bulb with an LED strip lamp holder.

2. Description of Related Art

As a light emitting diode (LED) has characteristics of low energy consumption, power saving, long service time, small size and quick response etc. LED is widely used in various kinds of illumination devices. For example, LED tubes now are used as daily lighting illuminations and gradually replace traditional fluorescent lamps.

In order to achieve desired amounts of luminance by using commercially available LED lamp, a plural of LED chips are provided in a circuit board and then the circuit board is combined with a lamp holder installed in a lamp head. An assembly of the LED bulb is completed after covering a transparent cover thereon.

However, the light emitted from above LED bulb is only toward one side of the circuit board that an omnidirectional lamp could not be achieved. Therefore, a plural of separating circuit boards are disposed in various directions on a light holder to achieve an omnidirectional lamp of LED bulb. Though this LED bulb can achieve a multi-directions illumination, the components number of the lamp is large and the assembly is time consuming. Moreover, the LED chips disposed on the circuit board cause problems of higher heat resistance, larger occupied space and higher cost. Besides, the luminance color of these LED chips is tended to be non-uniform because of disposing in different circuit boards.

In view of the above drawbacks, the Inventor proposes the present invention based on his expert knowledge and elaborate researches in order to solve the problems of related art.

### SUMMARY OF THE INVENTION

Accordingly, an object of the present invention is to provide an LED strip lamp holder for achieving an omnidirectional lamp and having a better heat dissipation effect.

In order to achieve the object mentioned above, the present invention provides an LED strip lamp holder for combining with a light head. The lamp holder includes an insulating lamp base, a pair of lead frames and an LED strip assembly. The insulating lamp base has two spaced apart through holes. The pair of lead frames is separately inserted in the two through holes. Each lead frame includes a heat conducting section and a supporting section. One end of the heat conducting section is inserted in the through hole, and the other end of the heat conducting section is connected with the supporting section. The two heat conducting sections are extended from the insulating lamp base to separate the two supporting sections from a surface of the insulating lamp base with a distance. The LED strip assembly includes a transparent carrier board, a plural of LED chips disposed on the transparent carrier board and a first transparent glue layer covered on the LED chips. The transparent carrier board is disposed crossing the two supporting sections.

Another object of the present invention is to provide a light bulb with LED strip lamp holder for achieving an omnidirectional lamp and having a better heat dissipation effect.

In order to achieve the object mentioned above, the present invention provides a light bulb with LED strip lamp holder. The bulb includes a light head, an LED strip lamp holder connecting on the light head and a transparent lamp shell covering the LED strip lamp holder and combined with the head. The lamp holder includes an insulating lamp base, a pair of lead frames and an LED strip assembly. The insulating lamp base has two spaced apart through holes. The pair of lead frames is separately inserted in the two through holes. Each lead frame includes a heat conducting section and a supporting section. One end of the heat conducting section is inserted in the through hole, and the other end of the heat conducting section is connected with the supporting section. The two heat conducting sections are extended from the insulating lamp base to separate the two supporting sections from a surface of the insulating lamp base with a distance. The LED strip assembly includes a transparent carrier board, a plural of LED chips disposed on the transparent carrier board and a first transparent glue layer covered on the LED chips. The transparent carrier board is disposed crossing the two supporting sections.

Comparing to the related art, the LED strip lamp holder of the present invention is provided with a pair of lead frames erected and spaced at interval on a lamp base. Then the lamp base is combined with a light head for constituting an LED bulb. As the LED strip assembly of the present invention is provided with a plurality of LED chips disposed on a transparent carrier board, the LED chips will emit light in multi-directions from the transparent carrier board and even penetrate the transparent carrier board as an omnidirectional lamp. Moreover, because the pair of the lead frames could be provided as a heat dissipating component and a heat conducting element, the heat generated from the LED chips can be dissipated or conducted through the lead frames. Thus the LED strip lamp holder and the bulb has a better heat dissipation effect and a longer service time.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of an LED strip lamp holder of the present invention;

FIG. 2 is an explosion perspective schematic view of an LED strip lamp holder of the present invention;

FIG. 3 is an assembly side view of an LED strip lamp holder of the present invention;

FIG. 4 is an application schematic view of an LED strip lamp holder of the present invention;

FIG. 5 is a perspective explosion view of a second embodiment of the present invention.

FIG. 6 is a perspective schematic view of a second embodiment of the present invention.

FIG. 7 is a perspective explosion view of a third embodiment of the present invention.

FIG. 8 is a perspective schematic view of a third embodiment of the present invention.

FIG. 9 is a perspective explosion view of a fourth embodiment of the present invention.

FIG. 10 is a perspective schematic view of a fourth embodiment of the present invention.

FIG. 11 is a perspective schematic view of a fifth embodiment of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

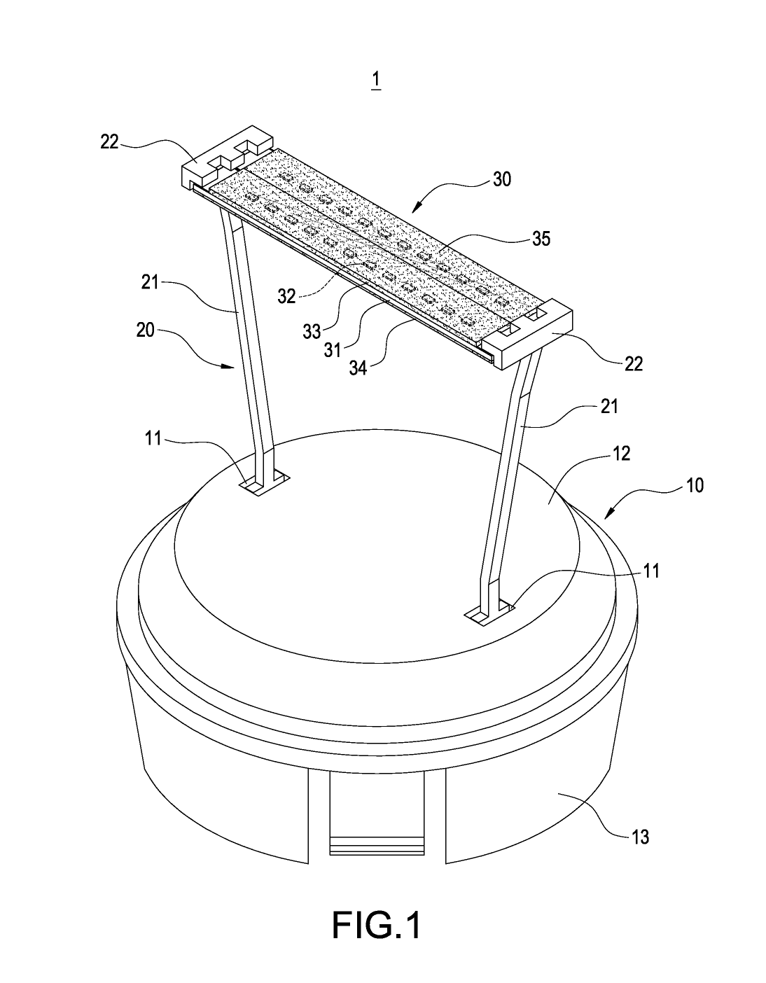

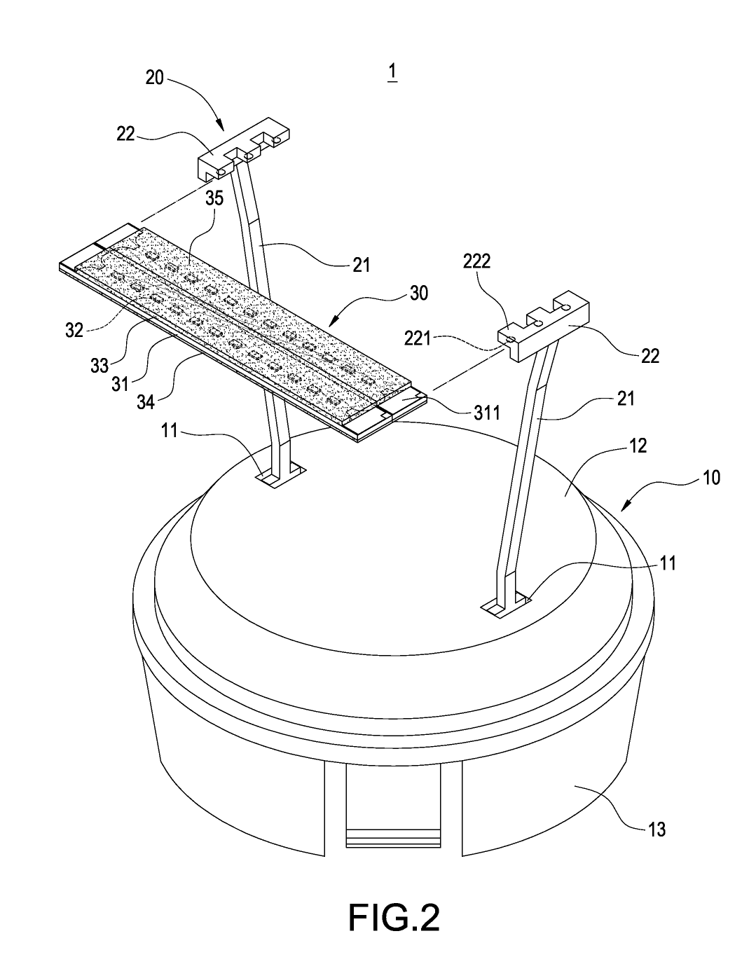

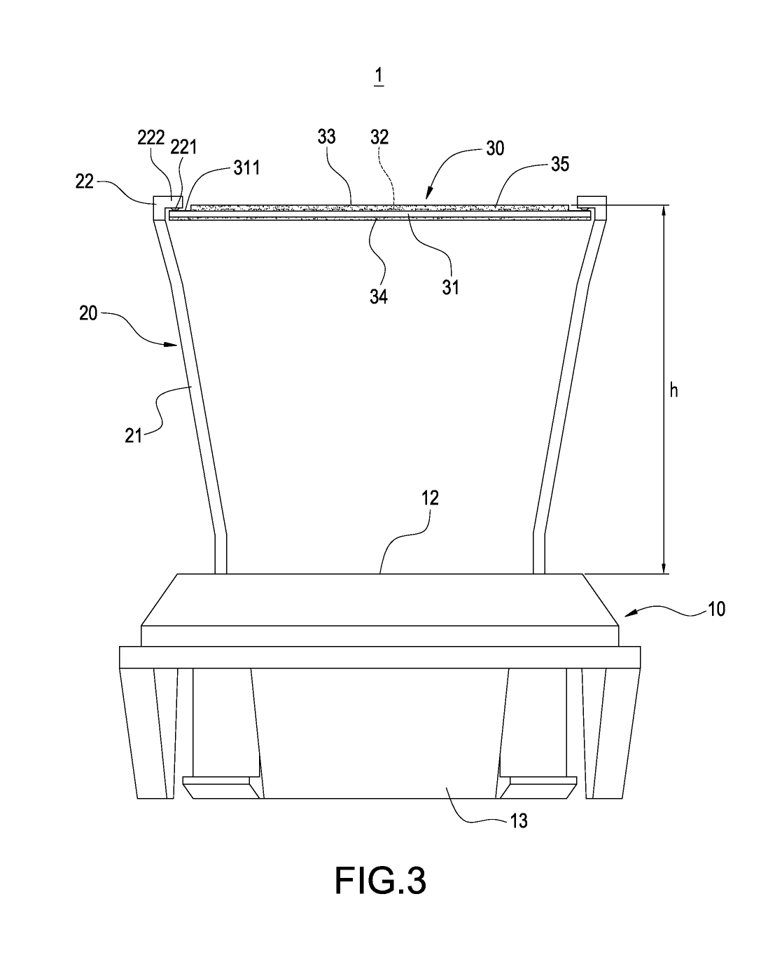

Please refer to FIG. 1 to FIG. 3, they depict a perspective schematic view, an explosion perspective schematic view and an assembly side view of an LED strip lamp holder of the present invention. An LED strip lamp holder 1 is disclosed in the present invention. The LED strip lamp holder 1 includes an insulating lamp base 10, a pair of lead frames 20 and an LED strip assembly 30. The pair of lead frames 20 is separately disposed in the insulating lamp base 10, and the LED strip assembly 30 is combined with the pair of lead frames 20.

The insulating lamp base 10 is made of electrically insulating materials. Preferably, the insulating lamp base 10 is made of electrically insulating and thermally conducting materials. The insulating lamp base 10 has two spaced apart through holes 11. In an embodiment of the present invention, the insulating lamp base 10 includes a supporting plate 12 and an annular barrel 13 enclosing a periphery of the supporting plate 12, and the supporting plate 12 has the two through holes 11 defined thereon.

The pair of lead frames 20 is separately inserted in the two through holes 11, and each lead frame 20 includes a heat conducting section 21 and a supporting section 22. In the present embodiment, the heat conducting section 21 and the supporting section 22 are in one piece form (or integrally formed). One end of the heat conducting section 21 is inserted in the through hole 11, and the other end of the heat conducting section 21 is connected with the supporting section 22. The two heat conducting sections 21 are extended from the insulating lamp base 10 to separate the two supporting sections 22 from a surface of the insulating lamp base 10 with a distance h.

The LED strip assembly 30 includes a transparent carrier board 31, a plural of LED chips 32 disposed on the transparent carrier board 31 and a first transparent glue layer 33 covered on the LED chips 32. The transparent carrier board 31 is provided with a circuit board (not shown), and the transparent carrier board 31 is disposed crossing the pair of lead frames 20 and the two supporting sections 22. In the present embodiment, the LED chips 32 are linearly arranged at equal intervals and are electrically connected with the circuit layer.

Moreover, the LED strip assembly 30 further includes a second transparent glue layer 34, and the second transparent glue layer 34 is disposed corresponding to the first transparent glue layer 33 on an opposing surface of the transparent carrier board 31. The first transparent glue layer 33 and the second transparent glue layer 34 are made of, but limited to, epoxy or silicone. The first transparent glue layer 33 is used to protect the LED chips 32, and the second transparent glue layer 34 is used to protect the transparent carrier board 31 and to uniform the light emitted from these LED chips 32.

Furthermore, the second transparent glue layer 34 or the first transparent glue layer 33 ,but not limit to, further includes a phosphor powder 35. In practice, the first transparent glue layer 33 and the second transparent glue layer 34 could simply be provided as a transparent layer only and do not mix with any phosphor powder. The phosphor powder 35 is used to convert wavelength with the partial light emitted from the LED chips 32 for providing wavelength conversion light. The wavelength conversion light will be mixed with the light emitted from the LED chips 32 to provide a mixed light with a specific light color.

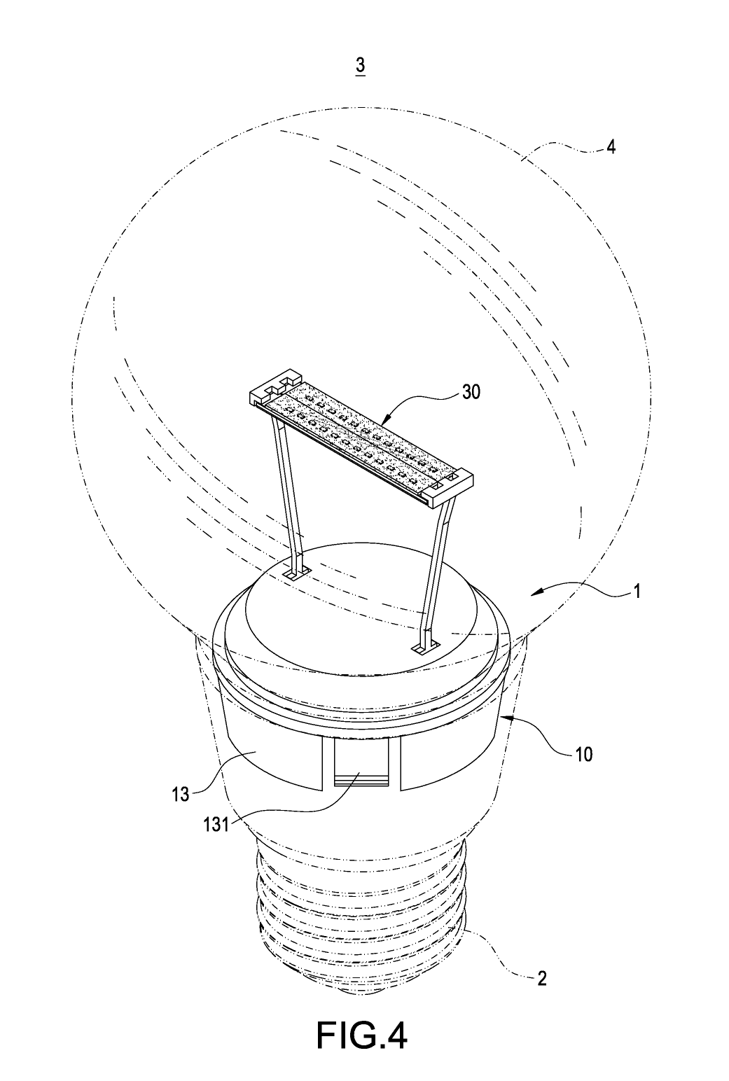

In more detail, the two supporting sections 22 have a plural of solder joints 221, and the transparent carrier board 31 has a plural of electrical conducting pads 311 correspondingly. The solder joints 221 are electrically connected with the electrical conducting pads 311 for the LED strip assembly 30 electrically connected with the pair of the lead frames 20. In the present embodiment, each supporting section 22 has provided with a plural of bumps 222 disposed at interval, and the solder joints 221 are, but not limited to, disposed on the bumps 222. Please refer to FIG. 4, it depicts an application schematic view of an LED strip lamp holder of the present invention. The LED strip lamp holder 1 is combined with a light head 2 such that a light bulb 3 with the LED strip lamp holder 1 can be constructed. The structure of the LED strip lamp holder 1 is described above. In an embodiment of the present invention, the annular barrel 13 has formed a pair of hooks 131, and the insulating lamp base 10 is combined with the light head 2 through the pair of the hooks 13.

As shown in FIG. 4, the light bulb 3 includes an LED strip lamp holder 1, a light head 2 and a transparent lamp shell 4. The LED strip lamp holder 1 is combined with the light head 2, and the transparent lamp shell 4 covering the LED strip lamp holder 1 is also combined with the head 2.

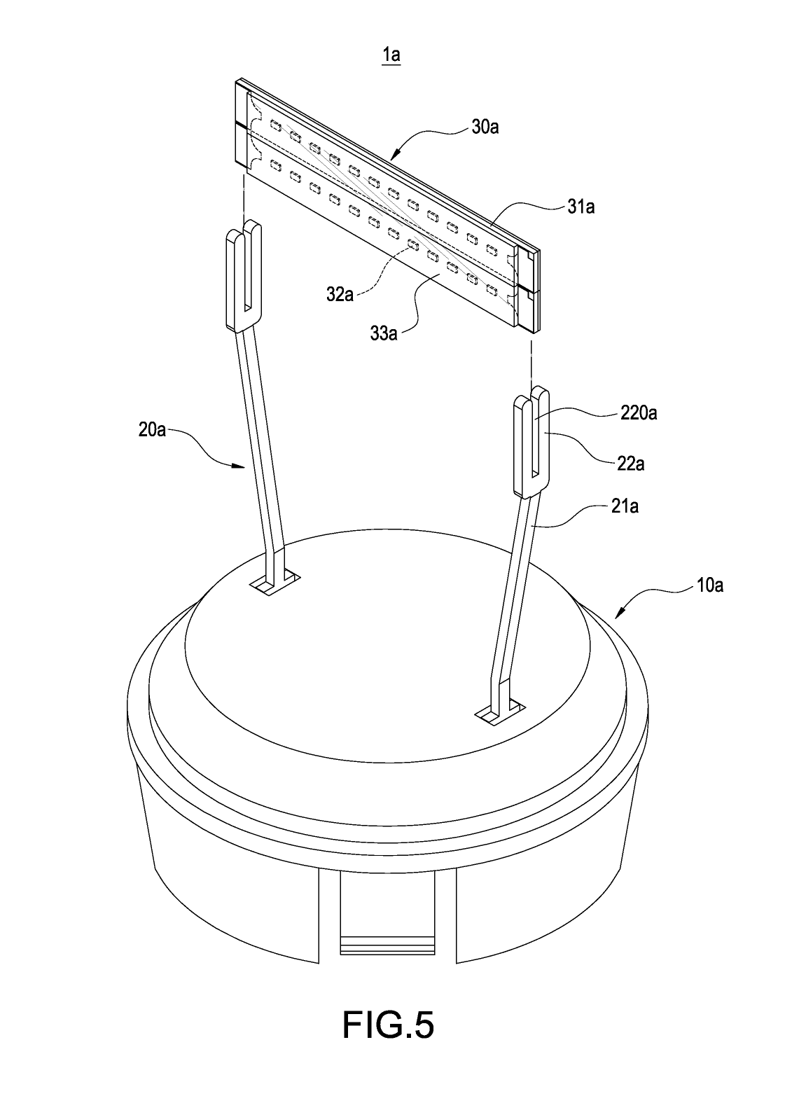

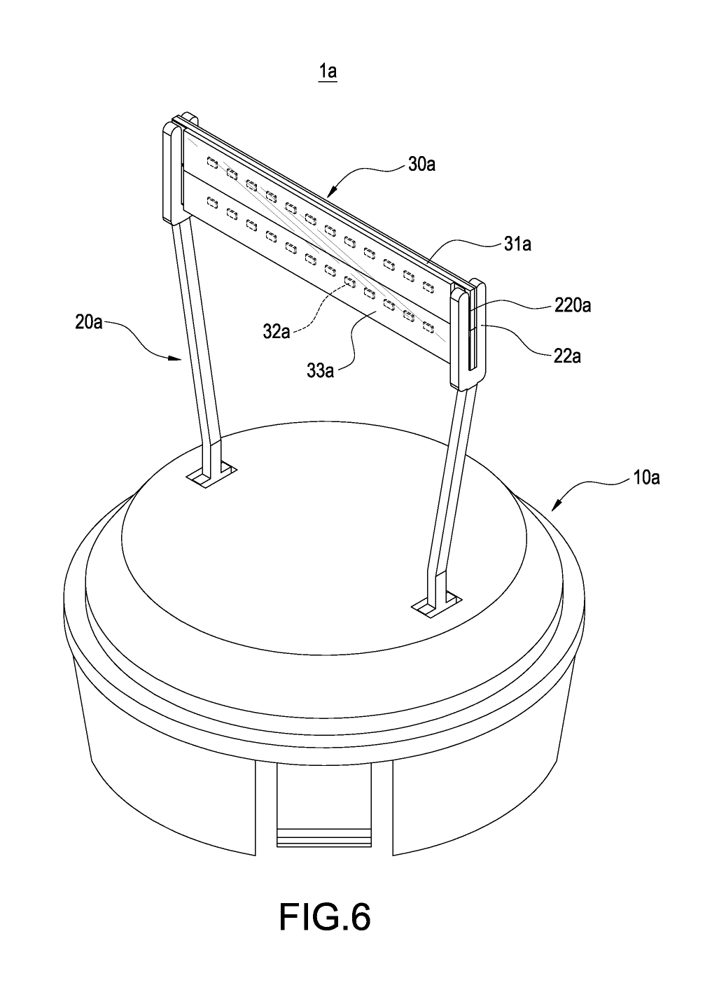

Please further refer to FIG. 5 and FIG. 6, they depict a perspective explosion view and a perspective schematic view of a second embodiment of the present invention. The present invention is substantially the same as the previous embodiment. A strip light LED 1a of the present invention includes an insulating lamp base 10a, a pair of lead frames 20a and an LED strip assembly 30a. The present invention differs with the first embodiment in that the combination types of the pair of lead frames 20a and the LED strip assembly 30a are different.

Each lead frame 20a includes a heat conducting section 21a and a supporting section 22a. In the present invention, the lead frame 20a is formed in a fork shape. The supporting section 22a has a slot 220a, and a cross section of the supporting section 22a is provided in a U shape. The LED strip assembly 30a includes a transparent carrier board 31a, a plural of LED chips 32a disposed on the transparent carrier board 31a and a first transparent glue layer 33a. Two ends of the transparent carrier board 31a are inserted in the corresponding slots 220a separately and combined with the supporting section 22a. In practice, the transparent carrier board 31 a (the LED strip assembly 30a) and the supporting section 22a (the lead frame 20a) is electrically connected through a wiring.

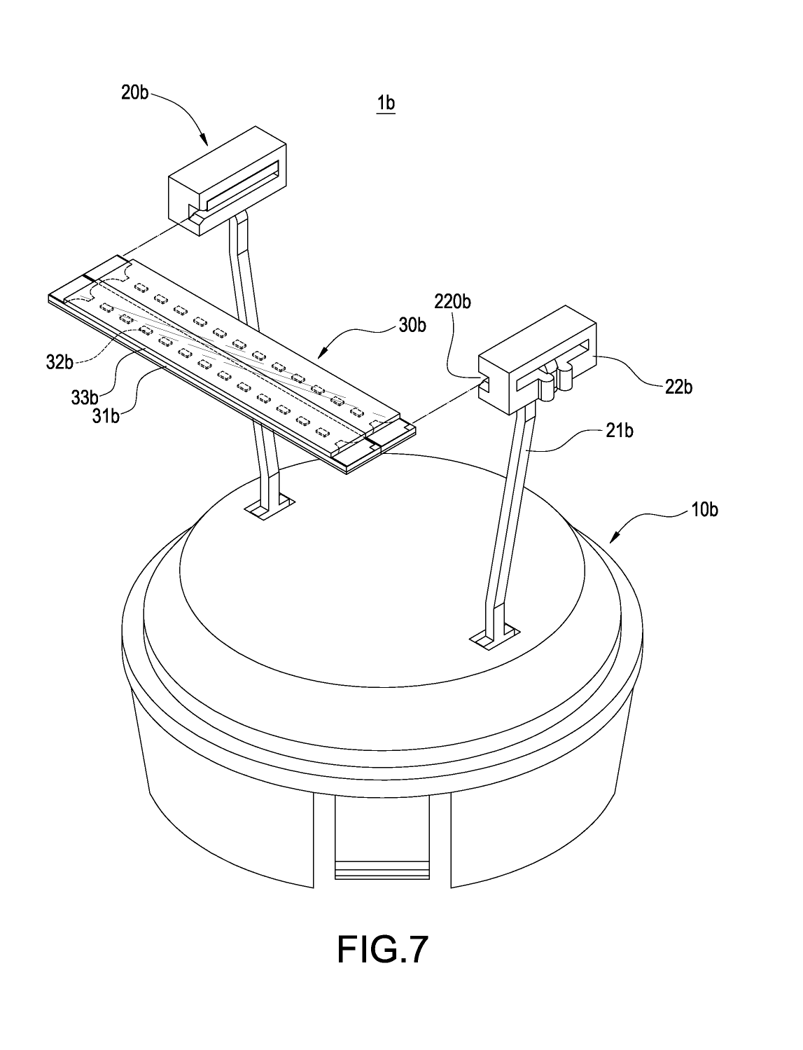

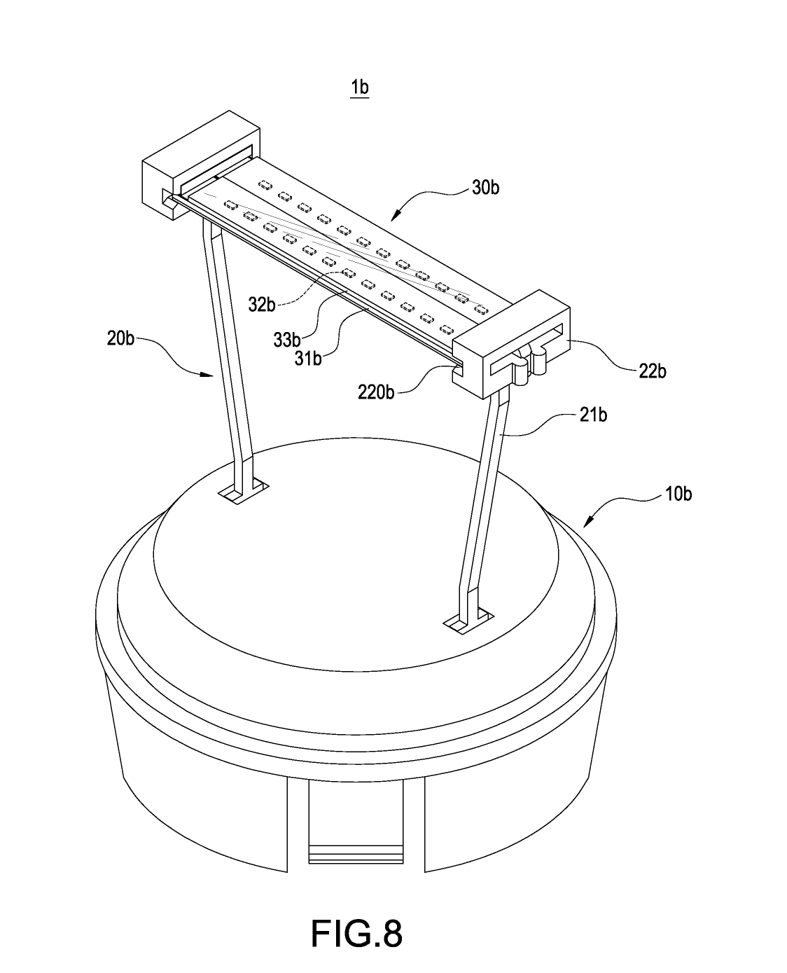

Please also refer to FIG. 7 and FIG. 8, they depict a perspective explosion view and a perspective schematic view of a third embodiment of the present invention. The present invention is substantially the same as the first embodiment. A strip light LED 1b of the present invention includes an insulating lamp base 10b, a pair of lead frames 20b and an LED strip assembly 30b. The present invention differs with the first embodiment in that the combination type of the pair of lead frames 20b and the LED strip assembly 30b is different.

Each lead frame 20b includes a heat conducting section 21b and a supporting section 22b. The LED strip assembly 30b includes a transparent carrier board 31b, a plural of LED chips 32b disposed on the transparent carrier board 31b and a first transparent glue layer 33b. In the present invention, the supporting section 22b is provided as a receiving seat, and a sliding slot 220b is provided on an opposite side of the supporting section 22b of the pair of the lead frames 20b. Two ends of the transparent carrier board 31b slides into the sliding slot 220b to combine the transparent carrier board 31b with the supporting section 22b. In practice, the transparent carrier board 31b is electrically connected through the pair of the lead frames 20b without a wiring process.

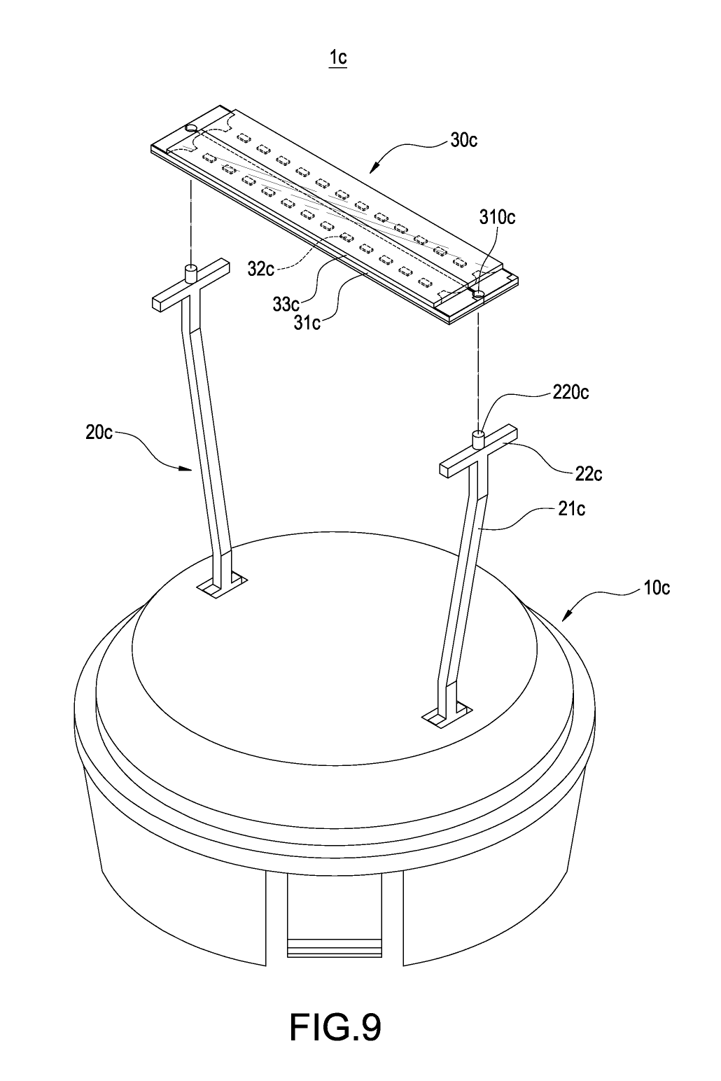

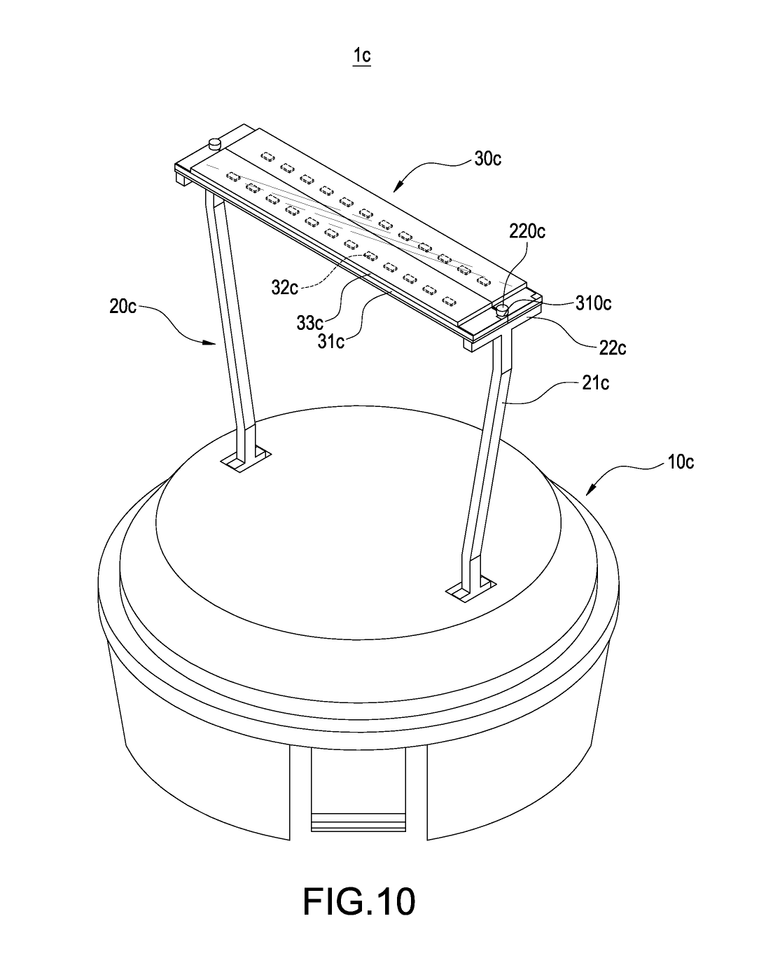

Please further refer to FIG. 9 and FIG. 10, they depict a perspective explosion view and a perspective schematic view of a fourth embodiment of the present invention. The present invention is substantially the same as the first embodiment. A strip light LED 1c of the present invention includes an insulating lamp base 10c, a pair of lead frames 20c and an LED strip assembly 30c. The present invention differs with the first embodiment in that the combination type of the pair of lead frames 20c and the LED strip assembly 30c is different.

Each lead frame 20c includes a heat conducting section 21c and a supporting section 22c. The LED strip assembly 30c includes a transparent carrier board 31c, a plural of LED chips 32c and a first transparent glue layer 33c. In the present invention, a cross section of the lead frame 20c is formed in a T shape, and each supporting section 22c has a positioning pillar 220c. Besides, a positioning hole 310c is provided on each of two ends of the transparent carrier board 31c separately, and the transparent carrier board 31c is combined with the supporting section 22c through the positioning of the positioning pillar 220c and the positioning hole 310. In this way, the LED strip assembly 30c will electrically connected with the lead frame 20c.

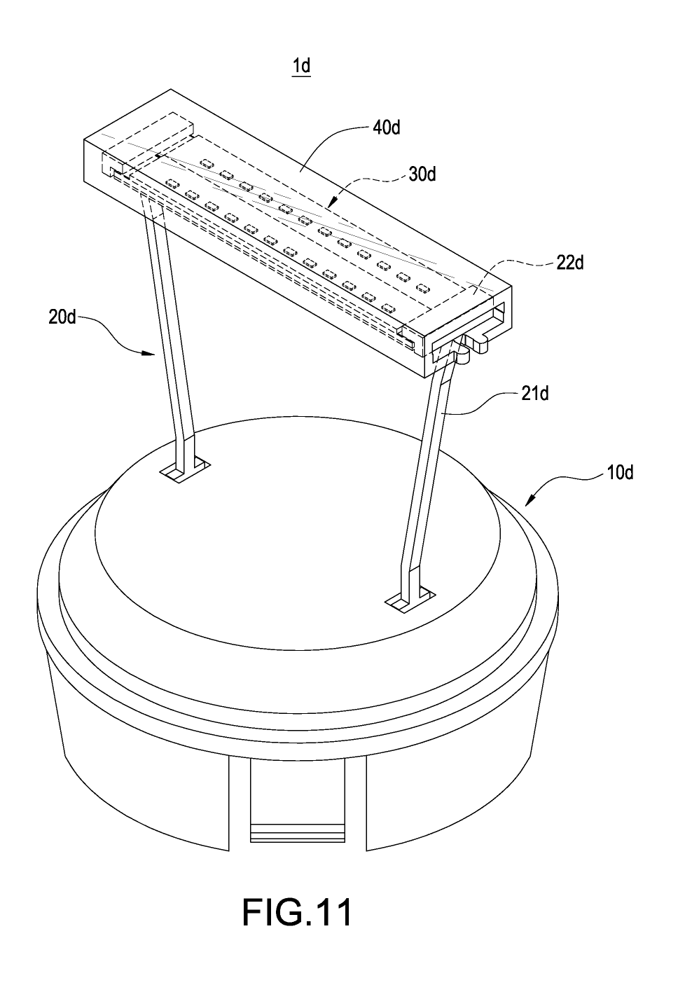

Please refer to FIG. 11, it depicts a perspective schematic view of a fifth embodiment of the present invention. The present invention is substantially the same as the first embodiment. A strip light LED 1d of the present invention includes an insulating lamp base 10d, a pair of lead frames 20d and an LED strip assembly 30d. Each lead frame 20d includes a heat conducting section 21d and a supporting section 22d. The shown embodiment differs with the first embodiment in that the pair of the lead frames 20d further includes a transparent cover 40d covering the supporting section 22d of the pair of the lead frames 20d and the LED strip assembly 30d.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. An LED strip lamp holder for combining with a light head, comprising:
an insulating lamp base having two spaced apart through holes;
a pair of lead frames separately inserted in the two through holes, each lead frame including a heat conducting section and a supporting section, one end of the heat conducting section inserted in the through hole, and the other end of the heat conducting section connected with the supporting section, the two heat conducting sections extended from the insulating lamp base to separate the two supporting sections from a surface of the insulating lamp base with a distance; and
an LED strip assembly including a transparent carrier board, a plural of LED chips disposed on the transparent carrier board and a first transparent glue layer covered on the LED chips, the transparent carrier board disposed crossing the two supporting sections.

2. The LED strip lamp holder according to claim 1, wherein the insulating lamp base includes a supporting plate and an annular barrel enclosing a periphery of the supporting plate, and the supporting plate has the two through holes.

3. The LED strip lamp holder according to claim 2, wherein the annular barrel has formed a pair of hooks, and the insulating lamp base is combined with the light head through the pair of the hooks.

4. The LED strip lamp holder according to claim 1, wherein the two supporting sections have a plural of solder joints, the transparent carrier board has a plural of electrical conducting pads correspondingly, and the solder joints are electrically connected with the electrical conducting pads.

5. The LED strip lamp holder according to claim 4, wherein each supporting section has provided with a plural of bumps disposed at interval, and the solder joints are disposed on the bumps.

6. The LED strip lamp holder according to claim 1, wherein each lead frame is formed in a fork shape, each supporting section has a slot and a cross section of the supporting section is provided in a U shape, two ends of the transparent carrier board are inserted in the corresponding slots separately and combined with the supporting section.

7. The LED strip lamp holder according to claim 1, wherein the supporting section is provided as a receiving seat, a sliding slot is provided on an opposite side of the supporting section of the pair of the lead frames, and two ends of the transparent carrier board slides into the sliding slot to combine the transparent carrier board with the supporting section.

8. The LED strip lamp holder according to claim 1, wherein a cross section of each supporting section is provided in a T shape, each of the supporting section has a positioning pillar, a positioning hole is provided on each of two ends of the transparent carrier board separately, the transparent carrier board is combined with the supporting section through the positioning of the positioning pillar and the positioning hole.

9. The LED strip lamp holder according to claim 1, wherein the pair of the lead frames further includes a transparent cover, the transparent cover covers the supporting section of the pair of the lead frames and the LED strip assembly.

10. The LED strip lamp holder according to claim 1, wherein the LED strip assembly further includes a second transparent glue layer, the second transparent glue layer is disposed corresponding to the first transparent glue layer on an opposing surface of the transparent carrier board.

11. The LED strip lamp holder according to claim 10, wherein the second transparent glue layer or the first transparent glue layer further includes a phosphor powder.

12. A light bulb with LED strip lamp holder, comprising:
a light head;
an LED strip lamp holder connecting on the light head, including:
an insulating lamp base having two spaced apart through holes;
a pair of lead frames separately inserted in the two through holes, each lead frame including a heat conducting section and a supporting section, one end of the heat conducting section inserted in the through hole, and the other end of the heat conducting section connected with the supporting section, the two heat conducting sections extended from the insulating lamp base to separate the two supporting sections from a surface of the insulating lamp base with a distance; and
an LED strip assembly including a transparent carrier board, a plural of LED chips disposed on the transparent carrier board and a first transparent glue layer covered on the LED chips, the transparent carrier board disposed crossing the two supporting sections; and
a transparent lamp shell combined with the light head and covered the LED strip lamp holder.

13. The light bulb according to claim 12, wherein the insulating lamp base includes a supporting plate and an annular barrel enclosing a periphery of the supporting plate, and the supporting plate has two through holes, the annular barrel has formed a pair of hooks, the insulating lamp base combined with the light head through the pair of the hooks.

14. The light bulb according to claim 12, wherein the two supporting sections has a plural of solder joints, the transparent carrier board has a plural of electrical conducting pads correspondingly, and the solder joints are electrically connected with the electrical conducting pads, each supporting section has provided with a plural of bumps at interval, and the solder joints are disposed on the bumps.

15. The light bulb according to claim 12, wherein each lead frame is formed in a fork shape, each supporting section has a slot and a cross section of the supporting section is provided in a U shape, two ends of the transparent carrier board are inserted in the corresponding slots separately and combined with the supporting section.

16. The light bulb according to claim 12, wherein the supporting section is provided as a receiving seat, a sliding slot is provided on an opposite side of the supporting section of the pair of the lead frames, and two ends of the transparent carrier board slides into the sliding slot to combine the transparent carrier board with the supporting section.

17. The light bulb according to claim 12, wherein a cross section of each supporting section is provided in a T shape, each of the supporting section has a positioning pillar, a positioning hole is provided on each of two ends of the transparent carrier board separately, the transparent carrier board is combined with the supporting section through the positioning of the positioning pillar and the positioning hole.

18. The light bulb according to claim 12, wherein the pair of the lead frames further includes a transparent cover, the transparent cover covers the supporting section of the pair of the lead frames and the LED strip assembly.

19. The light bulb according to claim 12, wherein the LED strip assembly further includes a second transparent glue layer, the second transparent glue layer is disposed corresponding to the first transparent glue layer on an opposing surface of the transparent carrier board.

20. The light bulb according to claim 19, wherein the second transparent glue layer or the first transparent glue layer further includes a phosphor powder.
